(19) United States
(12) Patent Application Publication
(10) Pub. No.: US 2003/0024238 A1
(43) Pub. Date: Feb. 6, 2003

(54) Habitat hydro scheme

(76) Inventor: William Ross Francis, Warrane (AU)

Correspondence Address: William Roos Francis, 181 Bligh Street, Warrane, 7018, AU

(21) Appl. No.: 10/182,761

(22) PCT Filed: Jan. 31, 2001
(86) PCT No.: PCT/AU01/00088

(30) Foreign Application Priority Data
Jan. 31, 2000 (AU) PQ 5335
Feb. 7, 2000 (AU) PQ 5457

(51) Int. Cl. F16D 31/02

(52) U.S. Cl. 60/398; 60/419

(57) ABSTRACT

A unit which converts wasted water into electric power, varied in size depending upon the amount of power required. A micro turbine (1) is driven by water under pressure by way of a reservoir tank (12) and pump (10) to turn the generators or alternators (2) which produce power to the Circular Battery Storage System (3). Once the water is used it is then returned (19) to the reservoir tank (12) to be used continuously as the process is repeated. The water may be salty, dirty or polluted. Where water is supplied by mains or rainwater tanks a ball type microturbine can be fitted to pipe stacks, waste pipes, down pipes or swimming pools. Wasted water from various natural sources can be minimized by the use of a barrel type microturbine.

This Invention relates to the conversion of frequently wasted water from various sources into energy by means of a microturbine generating power through the use of a battery storage system

Households, for example, do not usually use water again after it has been used for purposes such as bathing, washing, watering, flushing. Also advantage is not taken of all the water supplied through water mains, or water tanks with pressure pumps, because the pressure required to utilise water fittings in a household is not being used to the fullest extent possible.

Other systems using microturbines exist, however they all use fossil fuels to turn the generators or alternators thereby giving off toxic exhausts into the atmosphere As well, some use external water sources, but only once, thereby still wasting water that could be used to generate further power.

The Habitat Hydro Scheme uses a microturbine which is driven by water under pressure by way of a reservoir and pump to turn the generators or alternators; it therefore does not give off any toxic fumes. The Habitat Hydro Scheme then produces power through the generators or alternators to storage batteries. This enables the production of power on a continuing basis or when required. In the Habitat Hydro Scheme once the water is used it is then returned to the reservoir to be used time and time again, therefore no water is wasted.

The Invention is an individual unit of various sizes, depending on power demand, which is able to supply power, independently of other power supplies, anywhere in the world to:

Households

Caravans (fixed and portable)

All buildings (habitable)

Factories

Marine vessels

Subdivisions

Building sites

Automobiles

Multi-storey buildings (single or multiple floors)

Aircraft

Space ships

The major advantages of the Invention are that it can be used:—

In all areas where power supply is non-existent

As a back-up scheme where power supply is irregular or in short supply

In emergency situations

In crisis situations

In remote areas and villages where there is access to some water (even salt water or dirty or polluted water).

There are no on-going costs as the water used in the current application of electricity is wasted. There is no further cost to water suppliers as the water is already paid for. Therefore no water is wasted, except for a very small percentage from evaporation.

The unit can be carried by two people, for example as a do-it-yourself kit, by the licensed plumber and electrician who would then install it.

As the unit is an automatic self-circulating one, there is a one-off cost to the user except for ordinary maintenance.

In extremely cold areas (say 0 degrees-Minus 30 degrees) batteries can be supplied so as not to freeze and short-out.

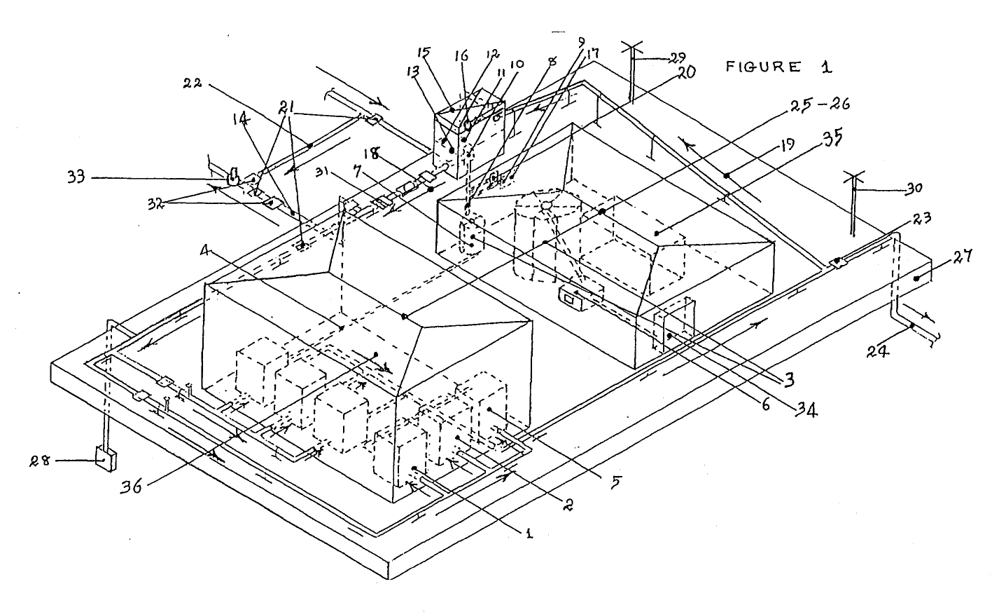

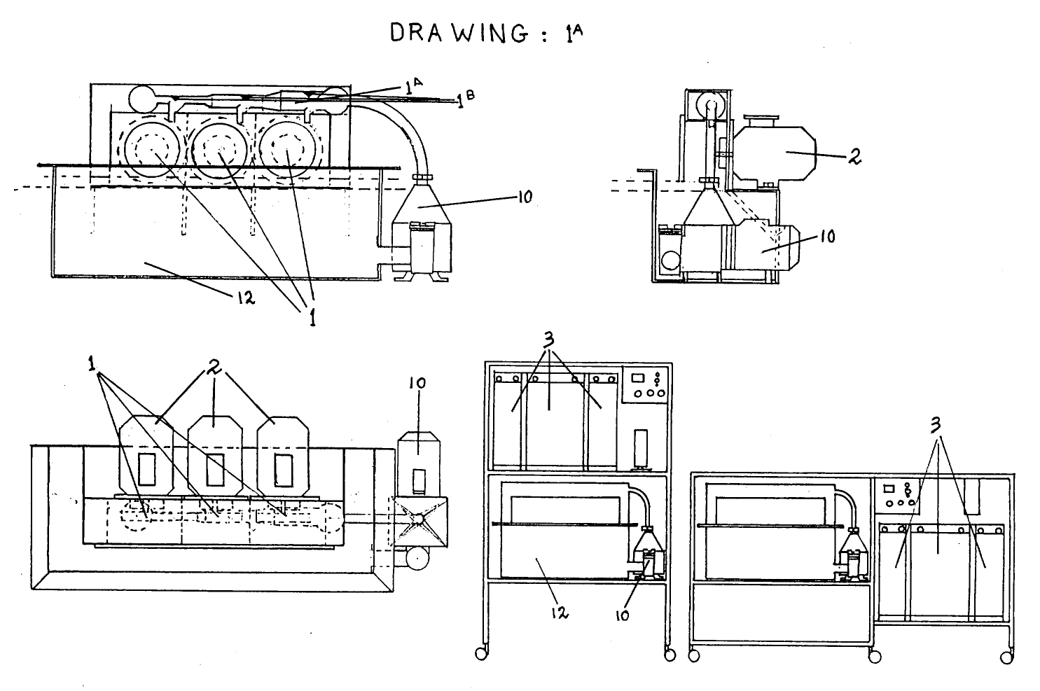

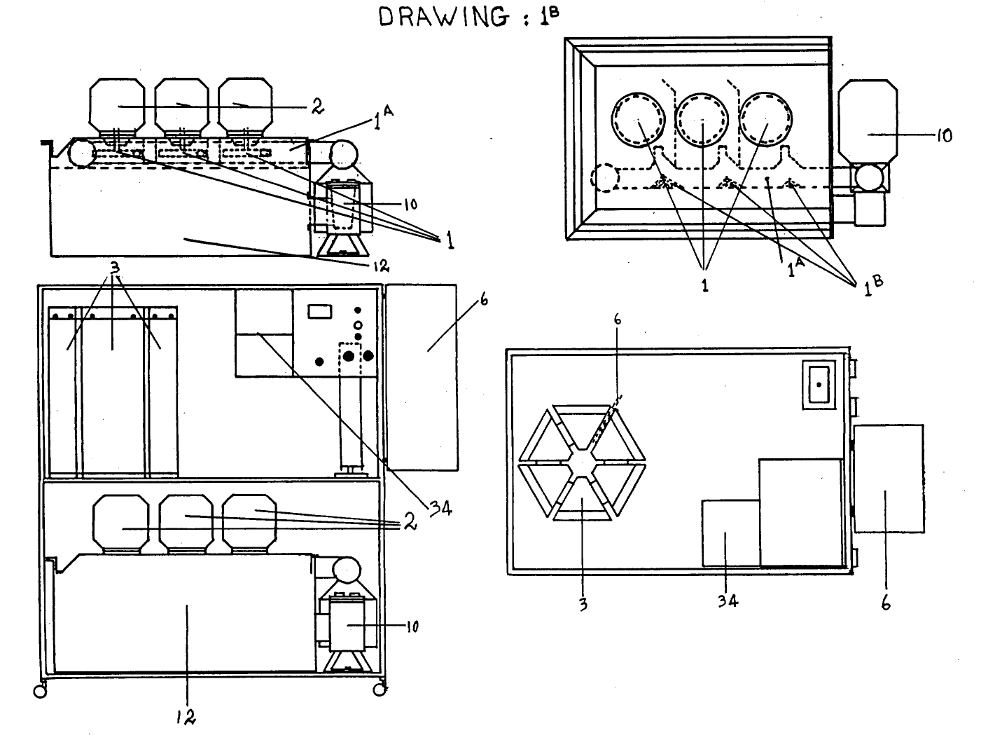

To assist with understanding the Invention the technical description of the Habitat Hydro Scheme follows. Reference will be made to the accompanying Drawing 1, FIG. 1.

The microturbine/s 1 rotate the 3-step alternator/s up to 2000 R.P.M., in three hours in contrast to a commonly used alternator, which takes seven hours. The alternator/s then give off 13.8 volts to 14.4 volts. Providing that a 12 volt Alternator/s is used this recharges the battery or battery banks 3 at 12 volts. If a 24 volt Alternator/s 4 is used then this charges a 24 volt battery or bank of batteries.

The turbine speed is geared 5 to a ratio to suit the Alternator or Generator used. A positive lead from the 3-step alternator runs to the positive post of the battery bank which can be either 12 volts or 24 volts. A negative lead runs to the negative post of the battery bank and/or to earth at a given point.

From the battery a positive lead and negative lead run to an inverter 6 changing the voltage from 12 or 24 volts (D.C.) to 240 volts (A.C.). 240 volt power is then ready for use.

If 3 Phase Power is required 240 volts will be supplied to a converter of suitable size to take 240 volts to 415 (A.C.) at the required quantity.

A secondary starting battery or batteries 7 is kept fully charged from the 3-step alternator/s, as a positive lead to these batteries is fitted with a single flow diode 8 to prevent power from being drawn from these batteries.

Inverters that can be used to produce 240 volts (A.C.) should not be less than

2000 watts@12 volt

2500 watts@24 volt

3000 watts@48 volt

If needed, more than one Inverter can be used e.g. −2 Banks of batteries to accommodate 2 Inverters and so OIL

Pure sine wave Inverters will give a cleaner power supply (see below).

(1) Power from Alternator

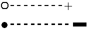

To Battery Bank

(2) Power from Battery Bank

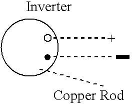

To Inverter

Inverter is earthed either to the framework of local power authorities or to a Copper Rod buried 2-3 ft into the ground.

In order to extend the life of the batteries, when 25% of the batteries have been discharged a solenoid switch 9 starts the Habitat Hydro system again by way of the water pump (bilge type) 10 until the batteries are recharged to 100% of capacity.

The size of the batteries to be used is governed by the amount of power storage that is demanded. For example, a three bedroom home with all modern conveniences could be well suited by 400 AMP hours of batteries, while a larger home may well require 900 AMP hours of battery storage.

The Habitat Hydro Scheme can run 24 hours every day, unlike other methods such as solar, wind, tidal. The design of the Circular Storage Battery System (Drawing 3) reduces the space needed to accommodate the batteries therefore reducing the size of the Habitat Hydro Scheme.

All leads used within the battery system are uniform, of the shortest length possible and exactly the same length.

The gauge of the cable is also governed by the cable length in order to avoid a voltage drop.

A 240 volt (A.C.) power line protection unit is fitted together with a 12 volt (D.C.) negative ground or floating ground.

The Inverter/s are of the combination type with a built-in battery charger and with a removable remote control panel which would be on site in dwelling.

A standard electrical specification for the Earth lead is all that is required for a ground Earth wire.

The Design of the water supply to the Habitat Hydro Scheme is as follows: Water is supplied to the system automatically by way of water mains or rainwater tanks, or even manually by buckets until all pipes 11 are filled and the reservoir tank 12 is filled to the required level, which is below the return pipe in the reservoir tank. The height of the water in the reservoir is 300 mm to 400 mm 13 depending upon the climate, so as to allow for the small percentage of evaporation caused by heat in a hot climate, and in the case of filling the reservoir tank manually, to replace the amount of water drawn off for household use 14. All pipes containing water are insulated and the reservoir tank is covered with a removable insulated lid 15 to minimise evaporation.

A ball (float) tap 16 maintains the water level in the reservoir tank automatically from water mains or rainwater tanks.

The power supply is switched on by a switch 17 close to the starting batteries, connecting power to the bilge pump/s in the reservoir tank. The water then begins circulating 18 through the system, turning the microturbine/s to generate the power to the batteries and returning the water 19 to the reservoir tank so that the pump/s can continue to circulate the same water through the system as many times that is required to charge the batteries fully (100%). When the batteries are discharged 25% a solenoid switch 20 switches on automatically and sets the pump working again to circulate the water to turn the microturbine/s and the whole process above is repeated until the batteries are again charged 100%

If the Habitat Hydro system is switched off at any time, for example to make repairs, a solenoid switch in the water line supply 21 to the household in conjunction with the solenoid switch in the power supply allows the water to fill the reservoir tank so that the water can be used in the household. Alternatively a by-pass 22 in the water supply to the reservoir tank is installed to supply the household with water direct from the water mains or rainwater tanks if the Habitat Hydro Scheme is not being used for any reason.

The Habitat Hydro system can be emptied by way of a gate valve 23 which is connected to a discharge pipe 24. Removable vented covers enclose the microturbine/s, alternator/s, generator/s and gears 26. The batteries, Invertor/s and all electrical Converters are covered in a similar manner 25.

The Habitat Hydro system is secured to a heavy duty reinforced (ribbed) plastic base 27 which is either a full base or in sections which are bolted or slotted together depending upon the size of the unit required.

In situations where power only is required the reservoir tank and bilge pump are not needed therefore the Habitat Hydro system can still be used by placing it on a pontoon or raft on still or calm waters, such as a pond, lake, or dam. A suction pump fitted with a debris guard 28 can be placed over the side of the pontoon or raft into the water at a suitable depth which would then draw water and disperse it through the microturbine/s and then return it to the pond, lake or dam. The same method can be used where water is iced over, by drilling a hole through the ice and inserting a suction pump to a suitable depth, and also where water is salt or contaminated.

A.C. 29 and D.C. 30 Lightning Conductors are fitted to the Habitat Hydro Scheme.

A flow switch 31 is fitted in close proximity to the reservoir tank in order to switch off power to the system if water fails to flow through the pipes. Check valves 32 stop any back pressure to the system and to maintain water in the dwelling. An adjustable pressure valve 33 is in place to adjust water pressure to the residence. The power box 34 is of a suitable size for all meters and gauges. There is sufficient space allowed for converters 35 to take 240 volts to 415 (A.C.). The generators 36 are an alternative if required.

The usage of water in a domestic situation where water is supplied by mains or rainwater tanks can be maximised to its fullest extent by the introduction of Ball Type Microturbines which are placed in pipe stacks, waste pipes, downpipes or swimming pools which have reticulating filtration plants. See specifications for the Ball Type Microturbine (Drawing 4).

Wastage of water flowing from rivers, streams, creeks, and regularly flooded areas, or falling from waterfalls and fountains, or gushing from geysers and springs can be minimised by the introduction of Barrel Type Microturbines. See specifications for the Barrel Type Microturbine (Drawing 2).

The complete Habitat Hydro Scheme, in combination with the Ball Type Microturbine, the Barrel Type Microturbine and the Circular Battery Storage System (Drawing 3 and specifications) is an environment-friendly, non-polluting, water-conserving and cost-effective means of producing electric power to cities, towns and rural areas throughout the world.

The Habitat Hydro Scheme can be adapted, with only minor modifications, to provide electric power to almost any region and situation where human beings exist.

### The Barrel Microturbine

The aim of the Barrel Microturbine (Drawing 2 is to enable water flowing from rivers, creeks, and regularly flooded areas, or falling from waterfalls (both man-made and natural) and fountains, or gushing from geysers, springs, etc. that would be otherwise wasted, to be used to supply energy.

To assist with understanding the Barrel Microturbine the technical description follows. Reference will be made to the accompanying Drawing 2. The Barrel Microturbine is a cylindrical barrel version FIG. 1 of the Ball Type Microturbine (Drawing 4). The Barrel Microturbine contains 24 blades 1. It differs from the Ball Type Microturbine in that each of the 24 blades is spaced evenly along a cylindrical barrel and is curved both along the full length of the barrel and across the blade 2. Each blade catches a volume of water which automatically begins propelling the Barrel Microturbine, the speed depending upon the volume of water which automatically begins propelling the Barrel Microturbine, the speed depending upon the volume of water flowing.

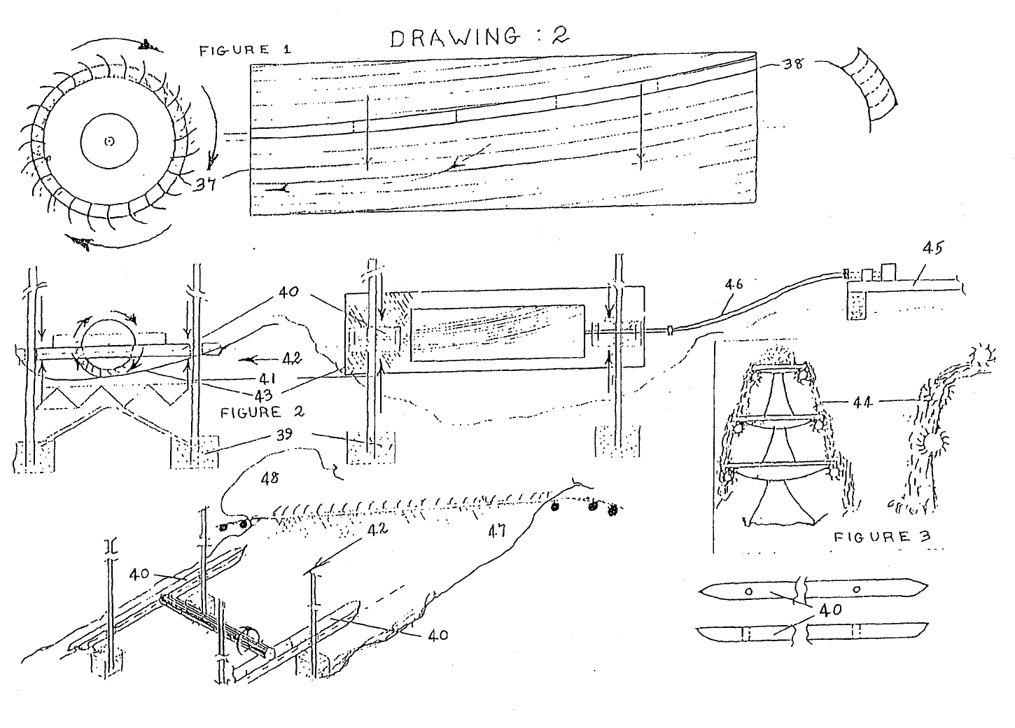

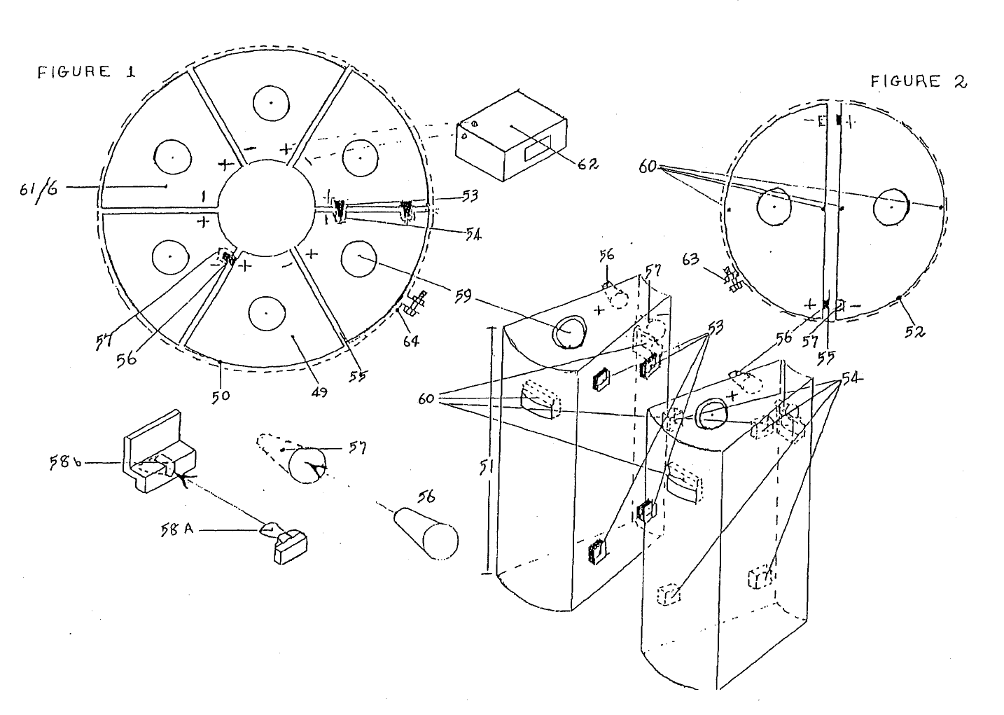

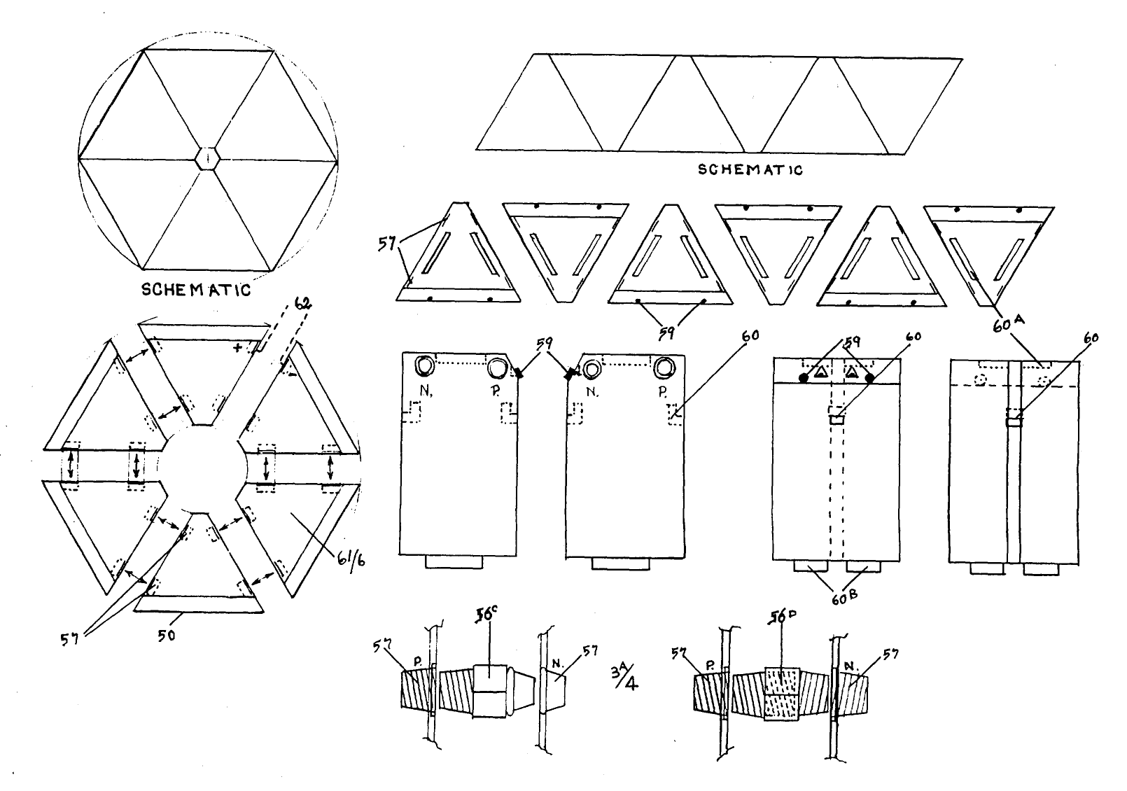

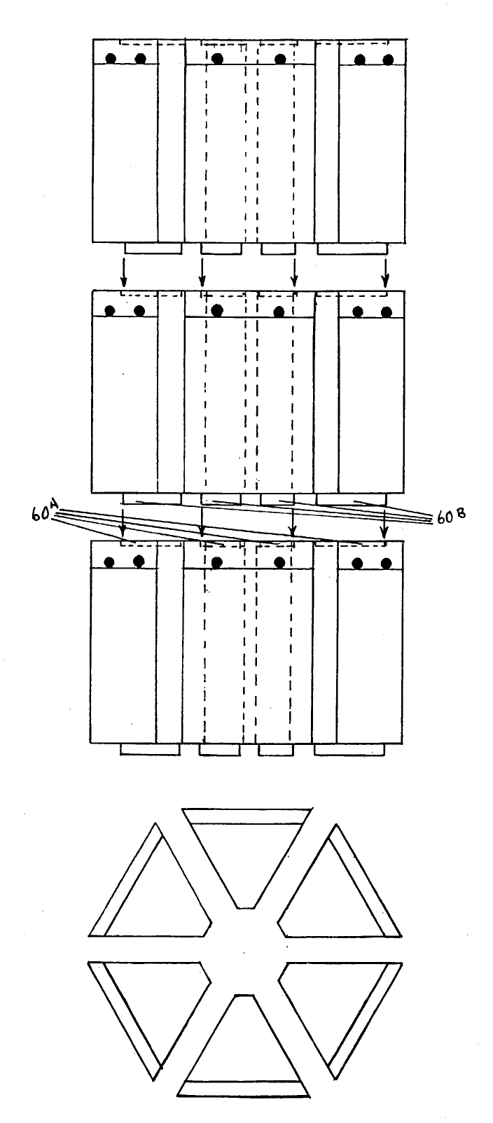

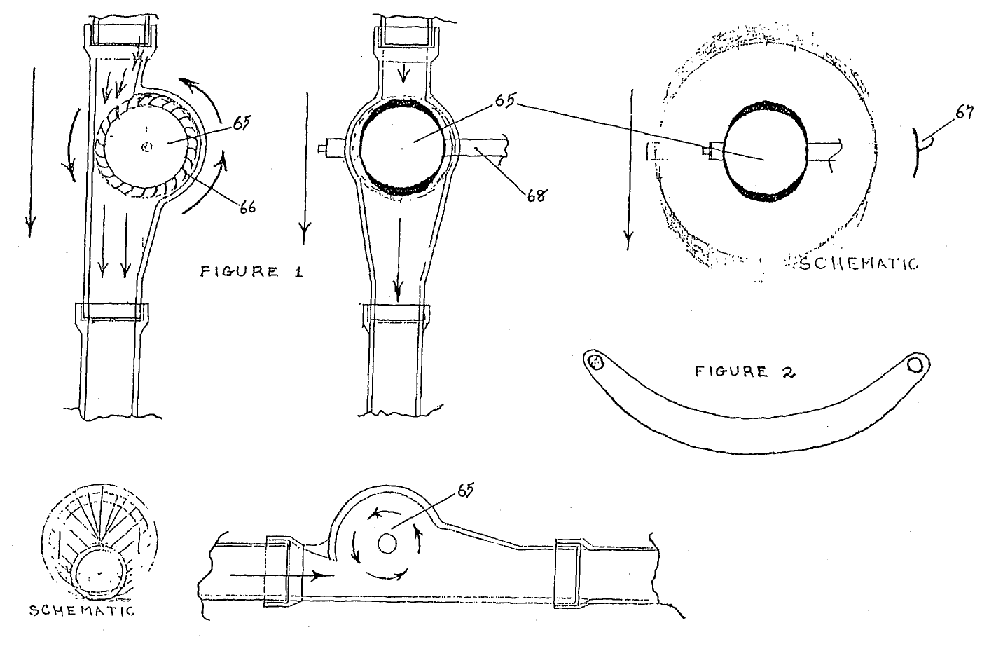

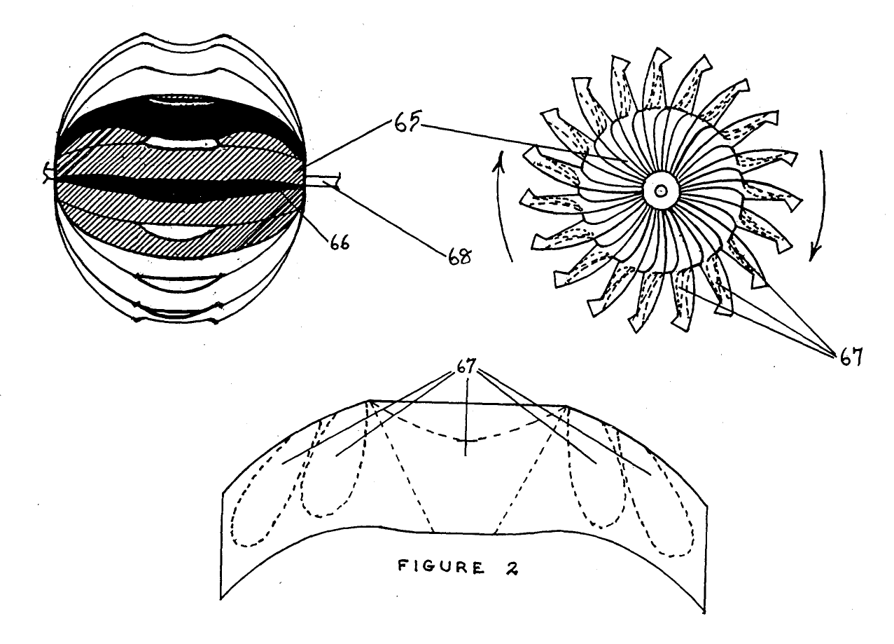

In the flowing, running or gushing water situation the Barrel Microturbine can be mounted in a fixed situation FIG. 2 3 on floats 4 so as to be allowed to rise and fall 5 with the fluctuations in the volume of water that is flowing down the stream, river natural waterfall, creek, regular flooded area, spring, geyser 6. In a river situation one or more Barrel Microturbines can be placed in a fixed position on floats across and along the river.

The Barrel Microturbine can also be used in square and rectangular downpipes on buildings. A steel mesh 7 is fixed under the Barrel Microturbine to trap debris.

In man-made waterfalls and fountains FIG. 3 the Barrel Microturbine can be situated wherever the water is being dispersed or flowing 8.

The Barrel Microturbine can (with minor adaptations) work in conjunction with the Habitat Hydro Scheme). By combining the two Microturbines both systems can be substantially reduced in size thus reducing the cost overall The Barrel Microturbine can be connected to an on-shore Habitat Hydro Scheme 9 by way of a flexible shaft 10 connected straight to the 3-step Alternator or Alternators (see Patent Application for Habitat Hydro Scheme) eliminating the need for bilge pumps, reservoirs, circulating pipes, or another external water supply.

A debris net 11 is placed up river some distance up stream from the floating Barrel Microturbine and debris is discharged in debris bay 12.

In suitable situations it is possible to combine the three systems, the Habitat Hydro Scheme together with the Ball Type Microturbine and the Barrel Microturbine.

The Circular Storage Battery System (Drawing 3) can be used in all systems singly and in any combination

### The Circular Storage Battery System

The Circular Storage Battery System is specifically designed to save space in the Habitat Hydro Scheme (see Patent Application for Habitat Hydro Scheme).

To assist with understanding the Circular Storage Battery System the technical description follows. Reference will be made to the accompanying Drawing 3.

Six Batteries FIG. 1 of 2 Volts each, made to a new wedge shape 1 can be assembled in a circle 2 to give a 12 Volt Circular Storage Battery System.

The height of each battery 3 may vary, e.g. 100 mm to give 100 Amp House (A.H.) storage capacity or 200 mm to give 200 AH., or 300 mm to give 300 A.H.

Alternatively, two Batteries of 6 Volts each FIG. 2, of semi-circular shape 4, of the same heights as above give the same A.H. storage.

Male lugs moulded into the battery case 5 projecting into the opposite female indentations 6 so as to leave a 10 mm expansion gap 7 gives more than sufficient room between batteries to give good ventilation and to keep the cells cool while charging is in progress. An alternative type of terminal post is shown in 10a and 10b.

Batteries may be produced as 2 Volt, 6 Volt and 12 Volt cases in the same shape and size as those mentioned above, and multiples of these can be joined together to give varying voltages, for example 12 Volt, 24 Volt, 48 Volt, 96 Volt, and so on depending on power requirements.

A screw type vented plug in the top of each battery, which would be flush with the top of the battery, allows the checking of electrolyte levels and the topping up of fluid.

Reinforced handle grips 12 are moulded into each battery case 13 for ease of lifting and carrying.

An Inverter 14 is at the closest point to the Battery Bank so as to keep voltage drop to a minimum

A hose clip 15 encircles the Battery Bank so as to keep the Battery Bank secure in a fixed position in order to maintain a positive connection between terminals.

Circular Storage Battery Systems can be stacked on top of each other depending on power requirements.

### The Ball Type Microturbine

The aim of the Ball Type Microturbine (Drawing 4) is to enable water in a domestic situation to be used to its fullest capacity.

Currently water from sources such as water mains, water tanks with pressure pumps, plumbing fixtures and round downpipes from roofs in households is not used to its fullest extent, for example after showering water is discharged and is not usually used further. More importantly it is not used to supply energy.

The Ball Type Microturbine can be used in conjunction with the Habitat Hydro Scheme (Drawing 1) in order to increase the storage power of the Circular Storage Battery System (Drawing 3) in the Habitat Hydro Scheme. Ball Type Microturbines can be installed in all plumbing fixtures such as waste pipes to bath, shower, basin, spa bath, sinks, troughs, washing machines, toilets (W.Cs.).

In a number of areas Ball Type Microturbines can be installed in the downpipes of any roof area and also may be installed in swimming pools with reticulating filtering plants.

To assist with understanding the Ball Type Microturbine the technical description follows. Reference will be made to the accompanying Drawing 4.

The Ball Type Microturbine is a spherical version FIG. 1 of the Barrel Microturbine (Drawing 4). It differs from the Barrel Microturbine in that instead of blades which fit along the barrel the blades follow the curvature of the ball 1. 24 blades 2 form the water catchment area 3 each blade having a two-curvature. 24 blades 2 form the water catchment area 3 each blade having a two-curvature. The shape and pattern of the 24 blades is shown in FIG. 2.

The Ball Type Microturbine is situated at the lowest point of a pipe stack, waste pipes or downpipes thereby producing the highest possible head of water to discharge on to the blades of the Ball Type Microturbine so as to give the maximum number of revolutions possible.

The shaft 4 from the turbine then turns a 3 stage Alternator or generator so as to produce storage power to the batteries similar to the system of the Habitat Hydro Scheme (Drawing 1) but with the absence of the reservoir tank and water reticulating pipes.

The absence of the reservoir tank and water reticulating pipes would mean that that the Habitat Hydro Scheme is greatly reduced in size and therefore can be installed in any convenient location such as under the house or externally, or in the duct area of larger buildings. The unit can be installed in existing buildings without a great deal of inconvenience.

The claims defining the invention are as follows:

1. Habitat Hydro Scheme comprising a main unit in a system which employs water which is used and then otherwise wasted, to generate energy and convert it into electric power, thereby avoiding the use of fossil fuels. The main unit in the Habitat Hydro Scheme system can be used with ordinary batteries, but the new space-saving Circular Storage Battery System is preferred. The main unit can be used independently, but in combination with the Ball Microturbine and the Barrel Microturbine enables the Habitat Hydro Scheme to be adapted to many varying situations.

2. The Habitat Hydro Scheme unit of claim 1 wherein it employs water which is used and then otherwise wasted comprises a portable miniature power system.

3. The Habitat Hydro Scheme unit of claim 1 wherein the portable miniature power system is a self-circulating apparatus in which water usage is maximised and water wastage is minimised by the use of a miniature pump/s which drives the water through the microturbine/s which is linked to a 3-step alternator or generator and returns the water to a miniature reservoir.

4. The Habitat Hydro Scheme unit of claim 1 wherein the miniature reservoir holds a minimum head of water which creates the pressure necessary to drive the microturbine/s.

5. The Habitat Hydro Scheme unit of claim 1 wherein the microturbine/s are driven by a Circular Battery Storage System specifically designed to save space and to fit securely in the unit.

6. The Habitat Hydro Scheme unit of claim 1 wherein to save space and to fit securely in the unit the batteries are designed in a wedge shape to sit in a circle or semi-circle enclosed by a hose clip.

7. The Habitat Hydro Scheme unit of claim 1 wherein for the Circular Battery Storage System a new method is devised of connecting the wedge-shaped batteries by positive and negative male and female connections.

8. The Habitat Hydro Scheme unit of claim 1 wherein the male and female lugs and indentations allow for the expansion of the wedge-shaped batteries.

9. The Habitat Hydro Scheme unit of claim 1 wherein for ease of moving and lifting the batteries the handgrips are built in to the battery case.

10. The Habitat Hydro Scheme unit of any one of claims 1 to 9 wherein a portable miniature base of heavy duty ribbed P.V.C. forms the foundation of the unit.

11. The Habitat Hydro Scheme of claim 1 wherein the Ball Type Microturbine is a spherical ball comprising 24 blades fixed around the ball at even spaces and having a two-way curvature on each blade.

12. The Habitat Hydro Scheme of claim 1 wherein the Ball Type Microturbine is a new plumbing invention specifically designed to be used in combination with the main unit of the Habitat Hydro Scheme.

13. The Habitat Hydro Scheme of claim 1 wherein the Ball Type Microturbine spherical ball is specifically designed to fit into water mains, water tanks with pressure pumps, plumbing fixtures, round downpipes and swimming pools with reticulation filtering plants in order to assist the Habitat Hydro Scheme unit to further minimise wastage of water from these areas.

14. The Habitat Hydro Scheme of claim 1 wherein the Barrel Microturbine is a cylindrical barrel comprising 24 blades which are spaced evenly along the cylindrical barrel and which are curved both along the full length of the barrel as well as across the blade.

15. The Habitat Hydro Scheme of claim 1 wherein the Barrel Microturbine is a new plumbing invention specifically designed to be used in combination with the main unit of the Habitat Hydro Scheme for insertion in square or rectangular downpipes and in flowing, running or gushing water situations, natural and man-made, where it is placed in a fixed situation on floats so as to rise and fall with fluctuations in the volume of water.

16. The Habitat Hydro Scheme of claims 1 to 15 as herein described with reference to the accompanying drawings.
